(19) United States
(12) Patent Application Publication
(10) Pub. No.: US 2008/0284239 A1
(43) Pub. Date: Nov. 20, 2008

(54) Brake System for a Vehicle

(76) Inventors: Ernst-Dieter Schaefer, Brackenheim (DE); Thomas Butz, Korntal-Muenchingen (DE); Guy-Edward Michalski, Darmstadt (DE); Marcel Munoz Greschuchna, Lehrensteinsfeld (DE); Christian Doberschuetz, Marbach (DE); Ralf Breit, Steinheim A.D. Murr (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/094,346

(22) PCT Filed: Oct. 27, 2006
(86) PCT No.: PCT/EP2006/067893

§ 371 Date: May 20, 2008

(30) Foreign Application Priority Data
Dec. 1, 2005 (DE) 10 2005 057 301.0

(51) Int. Cl. B60T 13/16

(52) U.S. Cl. 303/10

(57) ABSTRACT

The invention relates to a brake system for a vehicle having at least one brake circuit which includes at least one wheel brake, one inlet valve, one outlet valve, and one return device. The return device has at least one first pump device and one second pump device, having respective inlet valves and outlet valves. The pump devices have a delivery cycle offset from each other. An additional valve is located in every supply line of every pump device for preventing negative pressure produced in an intake phase of one of the pump devices from being applied to an inlet valve of another pump device.

### PRIOR ART

The present invention relates to a brake system for a vehicle, having a return pump situated in the brake circuit.

Various designs of brake systems for vehicles are known from the prior art. Usually, brake systems with two separate brake circuits are used. In addition, the brake circuits usually have regulating devices such as an antilock regulator or an electronic stability programming (ESP) regulator in order to improve the safety of the vehicle in various driving situations. Pumps are used to recirculate a hydraulic fluid in the brake circuit. Usually, at least one pump per brake circuit is provided for this.

### DISCLOSURE OF THE INVENTION

The brake system for a vehicle according to the invention, with the defining characteristics of claim 1, has the advantage over the prior art of an improved delivery rate. This is achieved according to the invention in that the brake system includes a return device that includes at least one first pump device and one second pump device that are hydraulically connected in parallel. The first and second pump devices each have an inlet valve and an outlet valve directly connected to them. In addition, the first and second pump devices are operated with delivery cycles that are offset from each other in order to produce as constant as possible a delivery rate, without the occurrence of pulsations. In the context of the present invention, the expression “delivery cycles that are offset from each other” is understood to mean that for example, the first pump device is in the suction phase while the second pump device is in the compression phase. Naturally, it is also possible to embody the offset delivery cycle so that the same phases can partially overlap each other. Also according to the invention, an additional valve is now situated in each intake line of each pump device. This additional valve prevents a negative pressure that is generated during the suction phase of one of the pump devices from also prevailing in an intake line of a second pump device. Consequently, the present invention makes it possible to operate two, three, or more pump devices in parallel with one another, without the occurrence of disadvantageous effects due to the respective offset delivery cycles of the individual pump devices. Consequently, overlaps of the pump devices can occur in the respective suction phase, without one of the pump devices being subjected to an unwanted negative pressure. This makes it possible to achieve a higher delivery rate and also to improve a conveyance of the intake flow, particularly in a shared intake line of the pump devices, which reduces the losses that occur. Consequently, the return device according to the invention is able to achieve an improved efficiency. The embodiment according to the invention is particularly simple and can be produced very inexpensively.

Preferred modifications of the invention are disclosed in the dependent claims.

In order to be able to achieve a particularly simple embodiment and a particularly inexpensive design, the additional valve is embodied in the form of a check valve without a spring. Consequently, a non-prestressed check valve is used, which is opened and closed only by the medium. Valves of this kind are also very low-maintenance.

It is also preferable if a line volume of a line segment situated between an additional valve and an inlet valve of a first pump device is approximately equal to a volume to be taken in by a second pump device is that is currently in the suction phase. This makes it possible to assure that a necessary fluid quantity of the first pump device, which is currently at the beginning of its suction phase, can be drawn from the existing line volume with no trouble until the second pump device has completed its intake procedure.

It is particularly preferable if a line volume between an additional valve and an inlet valve of a pump device is greater than or equal to a total filling volume of a pump device. This makes it possible for the entire intake quantity to be drawn from the line volume.

Preferably, three pump devices are situated in one brake circuit.

In another preferred embodiment, a pump device is a pump element of a radial piston pump. If three pump elements of a radial piston pump are provided as a return device, then they can be operated in delivery cycles that are offset from one another by a rotation angle of 120°. The pump elements here can be situated resting against one or two eccentric arrangements, with the suction phase of one pump element corresponding to a 180° rotation angle. The use of a radial piston pump with three pump elements as a delivery device permits a particularly compact and simple design.

Preferably, the brake system includes a first and second brake circuit, with at least one first and second pump device situated each brake circuit.

Alternatively, the return device can also be comprised of three separate pumps situated parallel to one another.

### DRAWINGS

A preferred exemplary embodiment of the invention will be described in detail below in conjunction with the accompanying drawings.

FIG. 1 schematically depicts a brake system according to one exemplary embodiment of the present invention and

FIG. 2 shows an enlarged partial view of a return device of the brake system shown in FIG. 1.

### DESCRIPTION OF THE EXEMPLARY EMBODIMENTS

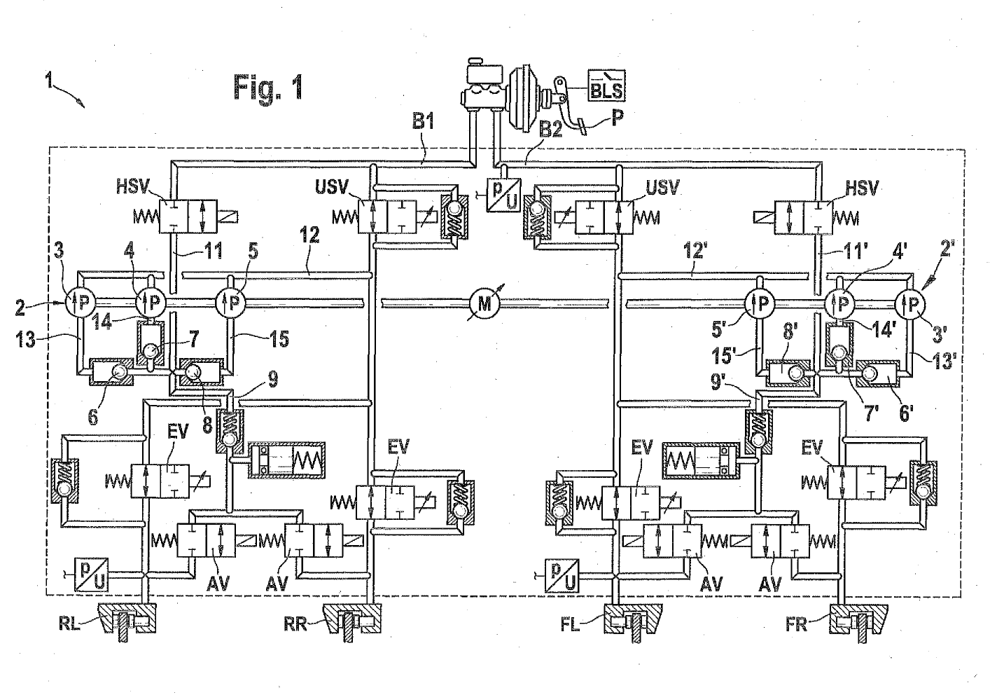

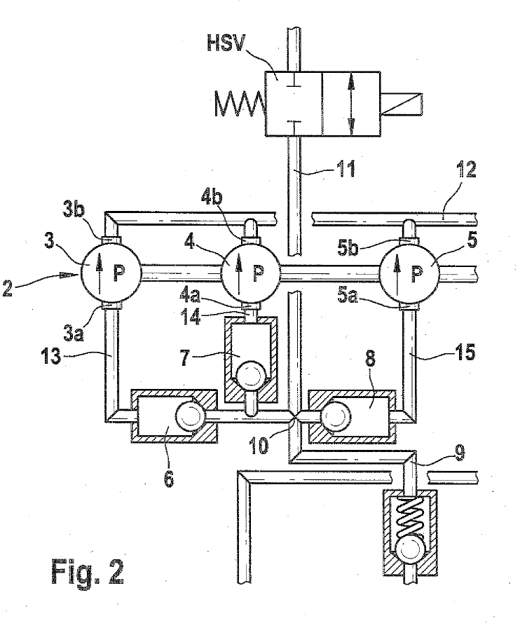

An exemplary embodiment of a brake system 1 according to the invention will be described below in conjunction with FIGS. 1 and 2. The brake system 1 is a brake system for a vehicle and has a first brake circuit B1 at a second brake circuit B2. The brake circuits are constructed in a known fashion with intake valves EV, outlet valves AV, a reversing valve USV, and a high-pressure switching valve HSV. The brake circuits B1 and B2 are hydraulically connected to a master cylinder that is actuated by means of a brake pedal P. The first brake circuit B1 is connected to the rear wheel brake cylinders RL and RR and the brake circuit B2 is connected to the front wheel brake cylinders FL and FR. The brake system 1 is embodied in the form of an electrohydraulic brake.

As is particularly clear from FIG. 1, the outlet valves AV are connected to a return line 2 via a shared intake line 9. As shown in FIG. 1, the return device 2 of the first brake circuit B1 includes a first pump device 3, a second pump device 4, and a third pump device 5. The return device 2 is embodied in the form of a radial piston pump and the pump devices 3, 4, 5 are each embodied as a respective pump element of the radial pump. As is particularly clear from FIG. 2, the shared intake line 9 branches at a junction point 10 into branch lines leading to the three pump devices 3, 4, 5 and an intake flow line 11 that is connected to the high-pressure switching valve HSV. Each of the three pump devices 3, 4, 5 here is associated with its own intake line. More precisely stated, the first pump device 3 is associated with a first intake line 13, the second pump device 4 is associated with a second intake line 14, and the third pump device 5 is associated with a third intake line 15. An additional valve is situated in each of the three intake lines 13, 14, 15. More precisely stated, a first additional valve 6 is situated in the first intake line 13, a second additional valve 7 is situated in the second intake line 14, and a third additional valve 8 is situated in the third intake line 15. The additional valves 6, 7, 8 here have the same design and are provided in the form of non-prestressed check valves. The additional valves 6, 7, 8 are thus opened and closed only by the hydraulic fluid. They are therefore inexpensive to produce and ruggedly designed. The additional valves 6, 7, 8 are arranged so that they open in the direction of the pump devices 3, 4, 5. A return device 2′ of the second brake circuit B2 is embodied the same as the return device 2 in the first brake circuit B1 and is labeled with the same reference numerals, each of which has a prime symbol (′) appended to it.

As is clear from FIG. 2, the first pump device 3 is provided with an inlet valve 3a and an outlet valve 3b, the second pump device 4 is provided with an inlet valve 4a and an outlet valve 4b, and the third pump device 5 is provided with an inlet valve 5a and an outlet valve 5b. The inlet valves 3a, 4a, 5a and outlet valves 3b, 4b, 5b respectively open during the suction and compression phases of the individual pump devices. The three pump devices 3, 4, 5 feed into a shared outlet line 12, which feeds into the brake circuits B1, B2, each in a respective section upstream of the inlet valves EV.

As is particularly clear from FIG. 2, the additional valves 6, 7, 8 are each situated in the intake lines 13, 14, 15 of the pump devices 3, 4, 5. A line volume between the additional valve 6, 7, 8 and the respective inlet valve 3a, 4a, 5a into the inlet line 13, 14, 15 is preferably the same for each inlet line. The volume between the additional valve and the inlet valve is preferably selected so that it is embodied for at least a partial filling of the respective pump device in order to permit a partial filling of the respective pump device during the beginning of its respective suction phase. Since in the current exemplary embodiment, the three pump devices 3, 4, 5 are embodied the form of pump elements of a radial piston pump, the respective suction phases of the pump devices 3, 4, 5 are offset from one another by a rotation angle of 120°. Since the suction phase of each pump device 3, 4, 5 corresponds to a rotation angle of 180°, there are overlaps from one pump device to another pump device in the suction phase. As a results at the beginning of its suction phase, each pump device is always acted on over a rotation angle of 60° by a negative pressure produced by another pump device, which is already in the final period of the suction phase. But since according to the invention, the additional valves 6, 7, 8 are provided in the intake lines 13, 14, 15, at the beginning of a suction phase of a pump device 3, 4, 5, there is a hydraulic separation in relation to the other intake lines so that it is possible to execute the intake procedure drawing from the fluid volume contained in the intake line. It is thus possible according to the invention to implement a filling procedure that has fewer losses. This makes it possible to significantly improve an efficiency of the return device 2.

1-8. (canceled)

9. A brake system for a vehicle, having at least one brake circuit (B1, B2) comprising:
at least one wheel brake, (RL, RR, FL, FR),
an inlet valve (EV),
an outlet valve (AV), and
a return device including at least one first pump device and one second pump device that each have an inlet valve and an outlet valve, the at least one first pump device and one second pump device having delivery cycles that are offset from each other, the return device also including an additional valve disposed in each intake line of each pump device in order to prevent a negative pressure generated during a suction phase of one of the pump devices, from being applied at an intake valve of another pump device.

10. The brake system according to claim 9, wherein the additional valve is a non-prestressed check valve.

11. The brake system according to claim 9, wherein a line volume of the intake line between the additional valve and an inlet valve of a first pump device is equal to a volume yet to be taken in by a second pump device in a suction phase.

12. The brake system according to claim 10, wherein a line volume of the intake line between the additional valve and an inlet valve of a first pump device is equal to a volume yet to be taken in by a second pump device in a suction phase.

13. The brake system according to claim 9, wherein a line volume of the inlet line between the additional valve and an inlet valve of a pump device is greater than or equal to a total filling volume of a pump device.

14. The brake system according to claim 10, wherein a line volume of the inlet line between the additional valve and an inlet valve of a pump device is greater than or equal to a total filling volume of a pump device.

15. The brake system according to claim 9, wherein precisely three pump devices are situated in one brake circuit (B1, B2).

16. The brake system according to claim 10, wherein precisely three pump devices are situated in one brake circuit (B1, B2).

17. The brake system according to claim 11, wherein precisely three pump devices are situated in one brake circuit (B1, B2).

18. The brake system according to claim 13, wherein precisely three pump devices are situated in one brake circuit (B1, B2).

19. The brake system according claim 9, wherein the return device is embodied in the form of a radial piston pump and the pump devices are pump elements of the radial piston pump.

20. The brake system according claim 10, wherein the return device is embodied in the form of a radial piston pump and the pump devices are pump elements of the radial piston pump.

21. The brake system according claim 11, wherein the return device is embodied in the form of a radial piston pump and the pump devices are pump elements of the radial piston pump.

22. The brake system according claim 13, wherein the return device is embodied in the form of a radial piston pump and the pump devices are pump elements of the radial piston pump.

23. The brake system according to claim 9, wherein the return device is comprised of a plurality of separate pumps.

24. The brake system according to claim 11, wherein the return device is comprised of a plurality of separate pumps.

25. The brake system according to claim 13, wherein the return device is comprised of a plurality of separate pumps.

26. The brake system according claim 9, wherein the brake system includes a first brake circuit (B1) and a second brake circuit (B2) and a return device is situated in each of the brake circuits (B1, B2).

27. The brake system according claim 11, wherein the brake system includes a first brake circuit (B1) and a second brake circuit (B2) and a return device is situated in each of the brake circuits (B1, B2).

28. The brake system according claim 13, wherein the brake system includes a first brake circuit (B1) and a second brake circuit (B2) and a return device is situated in each of the brake circuits (B1, B2).

29. The brake system according claim 19, wherein the brake system includes a first brake circuit (B1) and a second brake circuit (B2) and a return device is situated in each of the brake circuits (B1, B2).
